(19) United States
(12) Patent Application Publication
(10) Pub. No.: US 2013/0282286 A1
(43) Pub. Date: Oct. 24, 2013

(54) SYSTEM AND METHOD FOR CALIBRATING PERMEABILITY FOR USE IN RESERVOIR MODELING

(71) Applicant: Julian Thorne, Orange, CA (US)

(72) Inventor: Julian Thorne, Orange, CA (US)

(73) Assignee: Chevron U.S.A. Inc., San Ramon, CA (US)

(21) Appl. No.: 13/452,394

(22) Filed: Apr. 20, 2012

(51) Int. Cl. G06F 19/00; G01V 3/18

(52) U.S. Cl. 702/7

(57) ABSTRACT

A computer system and a computer-implemented method for calibrating a reservoir characteristic including a permeability of a rock formation. The method includes inputting a measured product KH of a measured permeability K and a flowing zone thickness H over a plurality of corresponding zones in one or more wells and inputting porosity logs for each measured product KH in each of the plurality of zones obtained from the one or more wells. The method further includes reading a porosity-permeability cloud of data points; calculating, for each zone, a predicted product KH from the porosity log using the porosity-permeability cloud of data points; determining one or more weighting coefficients between the predicted KH and the measured KH corresponding to each zone; and calibrating the measured permeability corresponding to each zone using the one or more weighting coefficients.

### FIELD

The present invention pertains in general to computation methods and more particularly to a computer system and computer-implemented method for calibrating permeability for use in reservoir modeling.

### BACKGROUND

A number of conventional models and methodologies are used to compute or simulate flow of fluids in a rock formation for reservoir forecasting of hydrocarbon production. For example, three dimensional (3D) geocellular reservoir model of porosity and permeability using statistics can be employed for reservoir forecasting of hydrocarbon production. However, permeabilities in such a geocellular reservoir model are generally not predictive for hydrocarbon forecasting unless dynamic data is used to calibrate permeabilities measured in core plugs with permeabilities assigned to geocellular model cells. The permeabilities of geocellular model cells are, naturally, orders of magnitude larger in size than the permeabilities obtained from core plugs.

One conventional method for performing this calibration process is by applying permeability multipliers during reservoir simulation to match production data in a process known as history matching. However, this method is time consuming and resource intensive. In addition, this calibration process is often performed at the end of building a reservoir model and without involving the reservoir model. As a result, the model is not “corrected” or enhanced by the calibration process.

Therefore, there is a need for a calibration method that cures these and other deficiencies in the conventional methods.

### SUMMARY

An aspect of the present invention is to provide a computer-implemented method for calibrating a reservoir characteristic including a permeability of a rock formation. The method includes inputting a measured product KH of a measured permeability K and a flowing zone thickness H over a plurality of corresponding zones in one or more wells and inputting porosity logs for each measured product KH in each of the plurality of corresponding zones obtained from the one or more wells. The method further includes reading a porosity-permeability cloud of data points; calculating, for each zone, a predicted product KH from the porosity log using the porosity-permeability cloud of data points; determining one or more weighting coefficients between the predicted KH and the measured KH corresponding to each zone, and calibrating the measured permeability corresponding to each zone using the one or more coefficients.

Another aspect of the present invention is to provide a system for calibrating a permeability of a rock formation. The system includes a computer readable memory configured to store input data comprising a measured product KH of a measured permeability K and a flowing zone thickness H over a plurality of corresponding zones in one or more wells, and porosity logs for each measured product KH in each of the plurality of zones obtained from the one or more wells. The system further includes a computer processor in communication with the computer readable memory, the computer processor being configured to: read a porosity-permeability cloud of data points; calculate, for each zone, a predicted product KH from the porosity log using the porosity-permeability cloud of data points; determine a weighting coefficient between the predicted KH and the measured KH corresponding to each zone; and calibrate the measured permeability corresponding to each zone using the one or more weighting coefficients.

A further aspect of the present invention is to provide a computer implemented method for calibrating a permeability of a rock formation. The method includes inputting, into the computer, a measured product KH of a measured permeability K by a flowing zone thickness H over a plurality of corresponding zones in one or more wells; and inputting, into the computer, permeability logs for each measured product KH in each of the plurality of zones obtained from the one or more wells. The method further includes calculating, by the computer, for each zone, a predicted product KH from the permeability log; determining, by the computer, one or more weighting coefficients between the predicted KH and the measured KH corresponding to each zone; and calibrating the measured permeability corresponding to each zone using the one or more weighting coefficients.

Yet another aspect of the present invention is to provide a system for calibrating a permeability of a rock formation. The system includes a computer readable memory configured to store input data comprising a measured product KH of a measured permeability K and a flowing zone thickness H over a plurality of corresponding zones in one or more wells, and permeability logs for each measured product KH in each of the plurality of zones obtained from the one or more wells. The system further includes a computer processor in communication with the computer readable memory, the computer processor being configured to: calculate, for each zone, a predicted product KH from the permeability log; determine a weighting coefficient between the predicted KH and the measured KH corresponding to each zone; and calibrate the measured permeability corresponding to each zone using the one or more weighting coefficients.

Although the various steps of the method according to one embodiment of the invention are described in the above paragraphs as occurring in a certain order, the present application is not bound by the order in which the various steps occur. In fact, in alternative embodiments, the various steps can be executed in an order different from the order described above or otherwise herein. For example, it is contemplated to transform from, the first model to the second model, or vice versa; or to transform from the third model to the second model, or vice versa; or yet to transform from the third model to the first model, or vice versa.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

In the accompanying drawings:

FIG. 1 is a flow chart of a method for calibrating a reservoir characteristic including a permeability of a rock formation, according to an embodiment of the present invention;

FIG. 2 is a schematic diagram representing a computer system for implementing the method, according to an embodiment of the present invention;

FIG. 3 depicts a plot of the original measured permeability as function of depth and facies of rock formation, according to an embodiment of the present invention; and

FIG. 4 depicts a graphical user interface for inputting data to obtain a calibrated permeability, according to an embodiment of the present invention.

### DETAILED DESCRIPTION

As will be described in detail in the following paragraphs, in one embodiment, a calibration method is described in which dynamic measures of permeability K from well-tests or measures of the product KH of permeability K with a flowing zone thickness H, are used to dynamically recalibrate a porosity-permeability cloud data points transform that is used in geostatistics so as to create a geocellular model of permeability. In one embodiment, the calibration method can be applied on sedimentary facies for use in facies-based geocellular modeling. In one embodiment, the calibration method may also account for uncertainty in the product KH. Distributions, such as, but not limited to, P10, P50 and P90, in porosity-permeability can be used in combination with other factors to estimate uncertainty of oil-in-place (OIP), for example, and thus estimate a recovery factor in an oil field being modeled.

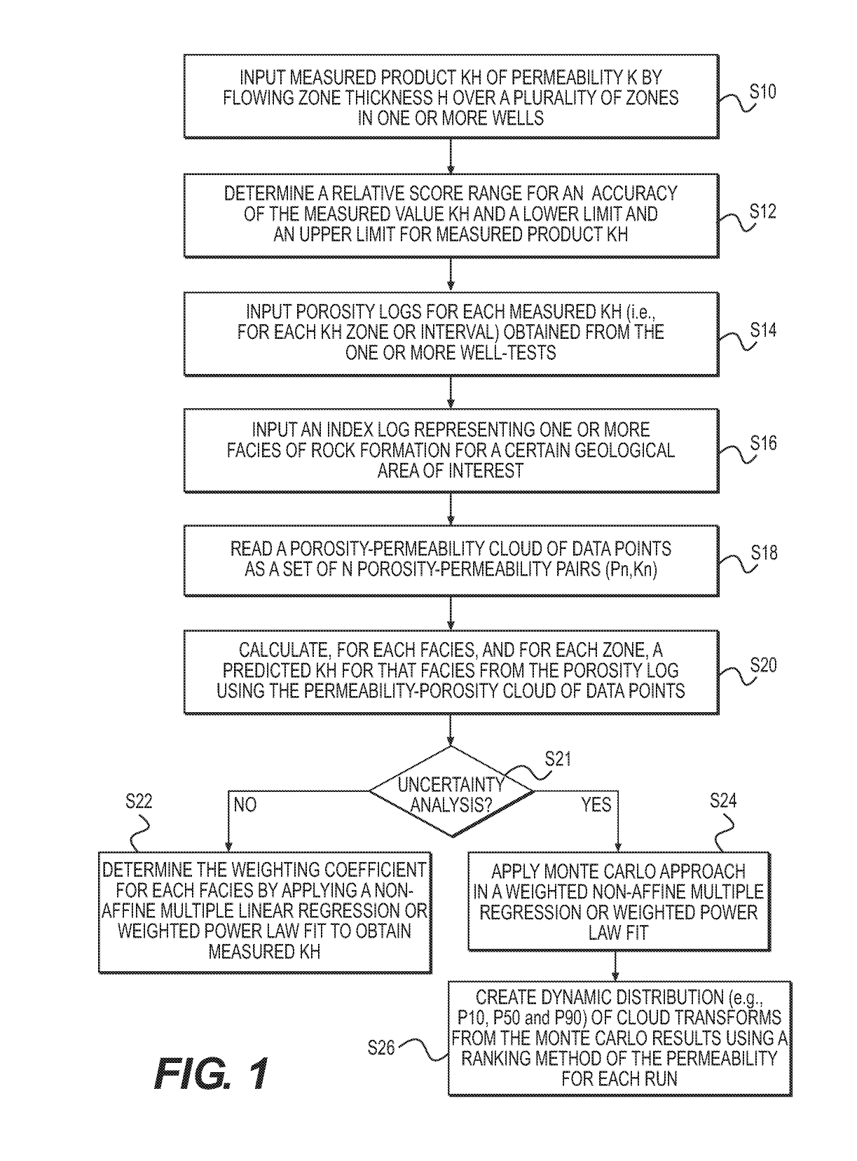

FIG. 1 depicts a flow chart of a method of calibrating reservoir characteristics (e.g., permeability) according to an embodiment of the invention. The method includes inputting, at S10, a measured product KH of permeability K by the dimension H representing the flowing zone thickness over a plurality of zones (m zones) in one or more wells. For example, the product KH in the plurality of zones in one or more wells can be obtained using well-test analysis. The product KH obtained from the well-test analysis for each zone m is referred to as the observed product KH for each zone m (OKHₘ), i.e., OKH₁ for zone 1, OKH₂ for zone 2, etc.

The method further includes, optionally determining a relative score range for an accuracy of the measured value OKHₘ and a lower limit and an upper limit for each measured value OKHₘ (OKH₁, OKH₂, etc.), at S12. In one embodiment, the lower and upper limit for a given well-test depends on whether the well-test is run for a long period of time enough to reach ‘infinite-acting’ time or steady state. The lower and upper limit for the well-test also depends if a pressure decline data in the well-test is well-matched by an analytical or numerical model and any other factors deemed relevant by a reservoir engineer.

The accuracy score range is a qualitative measure of the well-test in which, for example, a higher score is assigned the well-test if the well-test is conducted in a well and zone within the well in which complicating geological factors such as, for example, nearby faults or stratigraphic pinch outs are not thought to be present. The scoring is qualitative in nature as it involves a confidence level that a geologist or engineer has on the measured data from the well-test. In one embodiment, one possible implementation of a score range is to use numerical values between 0 and 10, for example. Hence, if a measurement A in a well-test is given a score range between 0 and 5, and a measurement B in the a well-test is given a score range between 5 and 10, for example. These score ranges imply that measurement A pessimistically has no value at all and optimistically has the same value as measurement B when measurement B has a pessimistic score.

The method further includes, at S14, inputting porosity logs for each measured value OKHₘ (i.e., for each zone or interval) obtained from the one or more well-tests. The method may further include optionally inputting, at S16, an index log representing one or more facies of the rock formation for a certain geological area of interest. A facies is a qualitative attribute that is assigned to a rock formation. For example, the facies of rock formation may be referred to as being “clean sand” (i.e., a sand having a relatively small proportion of clay in it) or may be referred to as being clay (i.e., a rock which is essentially clay), etc. Hence, a facies defines in general terms the rock type within the rock formation. A facies can also be seen as a statistical description or a statistical characterization of a rock volume. For example, a facies of rock formation can be described as being approximately 90% sand and 10% clay or vice versa, 90% of clay and 10% of sand, etc.

Therefore, in one embodiment, a three-dimensional data representing porosity logs for each KH zone or interval and for each facies index log are used as inputs in the calibrating method. In one embodiment, for each facies log index, a two-dimensional data representing a logarithm (log) of the measured permeability K or logarithm (log) of the measured product KH (OKHₘ) versus the porosity P or vice-versa, the porosity P versus the log of the measured permeability or log of the measured product KH (OKHₘ) can be plotted on a graph. The obtained graph is a plurality of data points representing the relationship between the log of the measured K or KH and porosity P.

The method further includes, at S18, reading a porosity-permeability cloud of data points (also referred to as the porosity-permeability cloud transform) as a set of n porosity-permeability pairs (Pₙ,Kₙ). In one embodiment, the porosity-permeability pairs (Pₙ,Kₙ) can be sorted by porosity, for example, sorted by increasing porosity or sorted by decreasing porosity. In one embodiment, the porosity-permeability cloud of data points can originate from core data and can be obtained, for example, in the laboratory, when analyzing core plugs, for example using mercury injection and other techniques. In another embodiment, instead of or in addition to a porosity-permeability cloud of data points, a theoretical relationship between porosity P and permeability K can be used. In one embodiment, the porosity-permeability cloud of data points can be used to calculate a permeability log and a porosity log. In another embodiment, instead of a porosity-permeability cloud of data points, a permeability log can be obtained directly over the plurality of intervals m in which case the step of calculating the permeability log and porosity log from porosity-permeability cloud transform can be eliminated.

The method further includes, at S20, for each facies, and for each interval or zone m, calculating a predicted KH for that facies from the porosity log using the permeability-porosity cloud of data points (permeability-porosity cloud transform). The average permeability for any depth in the interval m with a log porosity P is determined by the average permeability of all pairs Pₙ,Kₙ such that the porosity Pₙ are within a cumulative probability tolerance of porosity P. The tolerance is derived from the number of bins in the porosity permeability cloud data points.

A log KH for a given facies f (LKH_{f}) is equal to a sum of the product of the average permeability K by the sample spacing interval H over data samples j that are within the given facies f. This can be expressed by the following equation (1):

$${LKH}_{f} = {Σ}_{j} \overline{K} H \qquad ( 1 )$$

where K̅denotes the average of permeability K.

For example, for the sake of illustration, if there are two facies f₁ and f₂, equation (1) can be written as equation (2):

$${LKH}_{1} = {Σ}_{j} {\overline{K}}_{1} H \qquad ( 2 )$$

for facies f₁, where K̅₁ is the average permeability in rock with facies f₁, and as equation (3):

$${LKH}_{2} = {Σ}_{j} {\overline{K}}_{2} H \qquad ( 3 )$$

for facies f₂, where K̅₂ is the average permeability in rock with facies f₂.

Next, a determination is made as to whether uncertainty analysis is needed or not, at S21. In the case where no uncertainty analysis is needed and there is more than one facies, i.e., a plurality of facies (for example, facies f₁ and f₂), a non-affine multiple linear regression can be used to determine, at S22, the weighting coefficient W_{f} for each facies from the over-determined system of equations and summed over each facies, for each zone m to obtain the observed or measured OKHm. This can be expressed by the following equation (4):

$${Σ}_{j} {W}_{f} \times {LKH}_{f} = {OKH}_{m} \qquad ( 4 )$$

For example, if there are two facies (e.g., facies f₁ corresponding to clean sand and facies f₂ corresponding to dirty sand), a weighting factor or coefficient W₁ can be assigned to rock with facies f₁ and a weighting factor or coefficient W₂ can be assigned to rock with facies f₂. Similarly, a permeability log LKH₁ can be assigned to rock with facies f₁ and a permeability log LKH₂ can be assigned to rock with facies f₂. In this case, equation (4) can be rewritten as equation (5):

W₁×LKH₁+W₂×LKH₂=OKHₘ (5)

By using a simple regression, the weights W₁ and W₂ can be determined. In general, by using a regression method, the weights W_{f} corresponding to each facies can be determined.

If one or more of the weights W_{f} associated with one or more facies f is/are negative, that negative weight value can be replaced by a positive but relatively small weight. For example, in the example above, if the determined W₁ is negative for some reason, W₁ can be assigned a relatively small value close to zero to resolve the linear regression equations.

In one embodiment, the number m of zones is selected to be larger or equal to the number facies f. Alternatively, the number of facies can be selected to be smaller than the number of zones. To ensure this condition, the facies f types may be lumped together to reduce the number of facies f.

In another embodiment, when no uncertainty analysis is needed and there is only one facies (e.g., clean sand), a power law calibration can be implemented, at S22, that optimizes parameters a and b to fit the following equation (6):

a×LKHₘ^{b}=OKHₘ (6)

If uncertainty analysis is needed then a Monte Carlo approach can be used, at S24 in the weighted non-affine multiple regression or weighted power law fit above. In the Monte Carlo approach, the different weights for each observed or measured KH interval are randomly drawn from a relative accuracy score range for that well test described in the above paragraphs and the observed or measured KH is randomly drawn between the lower and upper limits also described in the above paragraphs.

In this case, a dynamic distribution (e.g., P10, P50 and P90) of cloud transforms can be created, at S26, from the Monte Carlo results using a ranking method, such as for example ranking by average, of the permeability for each run.

Therefore, as it can be appreciated from the above paragraphs, the method includes determining a weighting coefficient (one or more weighting coefficient associated with one or more facies) between the predicted product KH and the measured product KH. In one embodiment, the method further includes calibrating the measured permeability corresponding to each zone using the one or more weighting coefficients.

In one embodiment, the P10, P50, P90 calibrated porosity-permeability cloud transforms created, at S26, or in another embodiment P10, P50, and P90 calibrated permeability logs, can be used by geostatistical methods to create reservoir models suitable for flow simulation. A suite of flow simulation experiments can be used to predict the distribution of expected recoverable hydrocarbon volumes because the permeability used in the models has already been calibrated with dynamic flow information obtained from well tests.

In one embodiment, the method or methods described above can be implemented as a series of instructions which can be executed by a computer. As it can be appreciated, the term “computer” is used herein to encompass any type of computing system or device including a personal computer (e.g., a desktop computer, a laptop computer, or any other handheld computing device), or a mainframe computer (e.g., an IBM mainframe), or a supercomputer (e.g., a CRAY computer), or a plurality of networked computers in a distributed computing environment.

For example, the method(s) may be implemented as a software program application which can be stored in a computer readable medium such as hard disks, CDROMs, optical disks, DVDs, magnetic optical disks, RAMs, EPROMs, EEPROMs, magnetic or optical cards, flash cards (e.g., a USB flash card), PCMCIA memory cards, smart cards, or other media.

Alternatively, a portion or the whole software program product can be downloaded from a remote computer or server via a network such as the internet, an ATM network, a wide area network (WAN) or a local area network.

Alternatively, instead or in addition to implementing the method as computer program product(s) (e.g., as software products) embodied in a computer, the method can be implemented as hardware in which for example an application specific integrated circuit (ASIC) can be designed to implement the method.

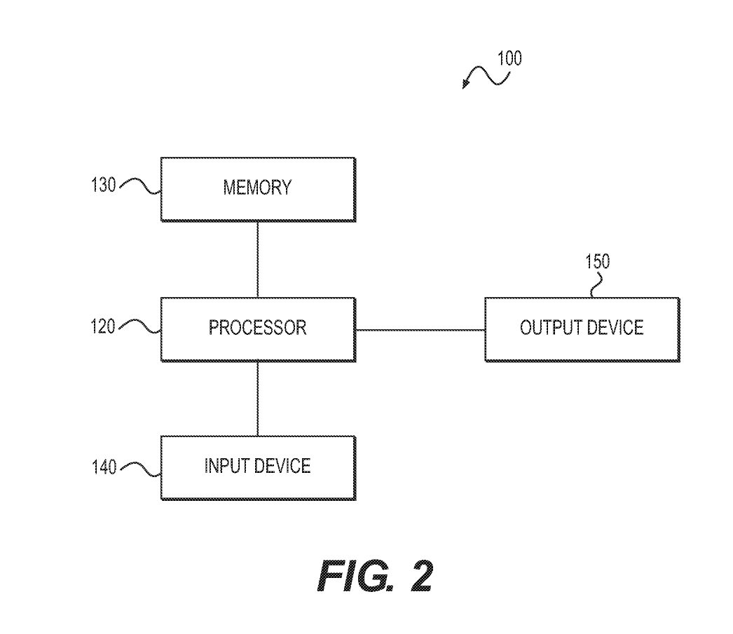

FIG. 2 is a schematic diagram representing a computer system 100 for implementing the method, according to an embodiment of the present invention. As shown in FIG. 2, computer system 100 comprises a processor (e.g., one or more processors) 120 and a memory 130 in communication with the processor 120. The computer system 100 may further include an input device 140 for inputting data (such as keyboard, a mouse or the like) and an output device 150 such as a display device for displaying results of the computation.

As can be appreciated from the above description, the computer readable memory 100 can be configured to store input data having a measured product KH of permeability K by flowing zone thickness H over a plurality of zones in one or more wells, and porosity logs for each measured product KH in each of the plurality of zones obtained from the one or more wells. The computer processor 120 in communication with the computer readable memory 130 can be configured to: (a) read a porosity-permeability cloud of data points; (b) calculate, for each zone, a predicted product KH from the porosity log using the porosity-permeability cloud of data points; (c) determine a weighting coefficient between the predicted product KH and the measured product KH corresponding to each zone; and (d) calibrate the measured permeability corresponding to each zone using the one or more weighting coefficients.

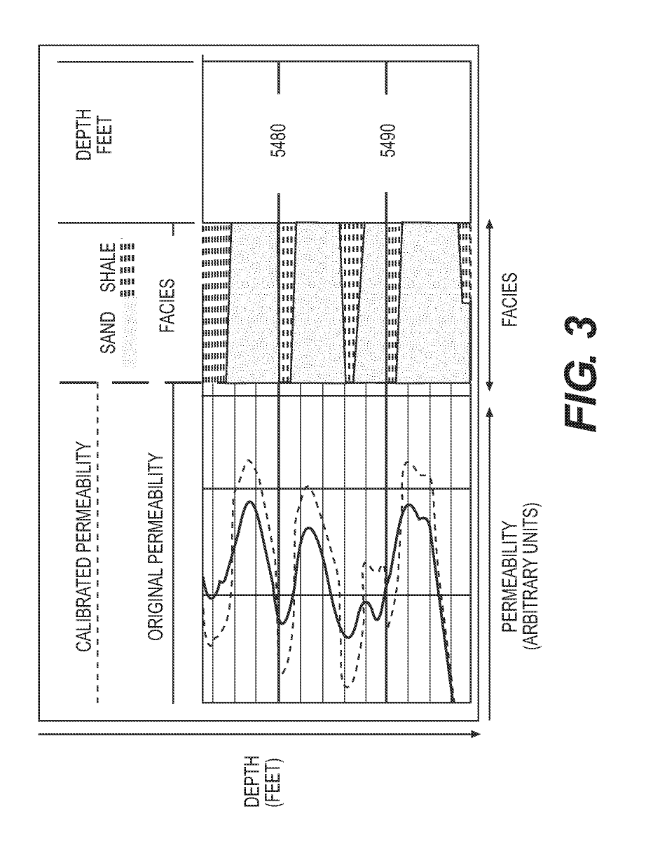

FIG. 3 depicts a plot of the original measured permeability as function of depth and facies of rock formation, according to an embodiment of the present invention. On the ordinate axis is represented the depth and on the abscissa axis is represented the permeability. The solid line shows the variation curve of the original measured permeability as a function of depth and thus as a function of depth. The doted line represents the calibrated permeability curve, i.e., the permeability that is calibrated using the weighting coefficients extracted from dynamic flow information or porosity logs for each KH zone or interval obtained from well tests. Hence, the effect of calibration and thus the effect of weighting coefficient can be seen in the difference between the original measured permeability curve and the calibrated permeability curve. A facies profile is also plotted as a function of depth. In FIG. 3, sand is represented by dots and shale is represented by dashed lines. The difference between the original measured permeability curve and the calibrated permeability curve is correlated with the variation of facies profile as a function of depth. In other words, the original permeability is rescaled by a facies dependent multiplier (weighting factor) to create the calibrated permeability. As can be understood from FIG. 3, in this example the sandy facies has a multiplier greater than 1 while the shaly facies has a multiplier less than 1. The calibrated permeability shown here is the P50 permeability. A P90 permeability will have higher permeabilities while the P10 will have lower permeabilities.

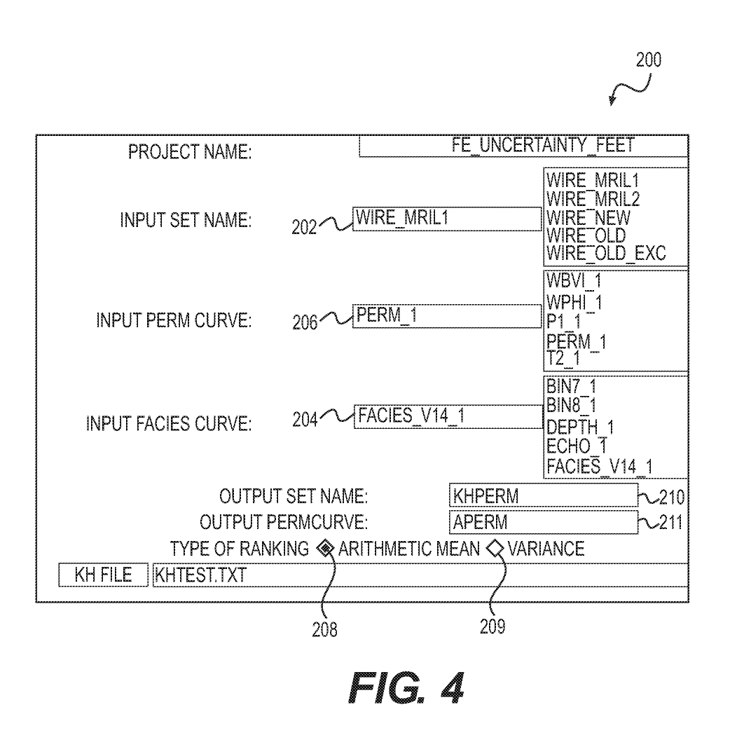

FIG. 4 depicts a graphical user interface for inputting data to obtain a calibrated permeability, according to an embodiment of the present invention. The graphical user interface (GUI) 200 has various reserved windows for inputting various input data files such as inputting a file name containing measured permeabilities at 202, inputting a file name for facies profiles or curves at 204, inputting a file name for porosity logs associated with KH data from well-tests at 206, selecting a type of ranking statistics such as ranking by arithmetic mean at 208 or variance at 209. The graphical interface also includes a window for specifying a name for the output set at 210 and a file name for the output permeability curve prefix at 211 to produce P10, P50 and P90 curves.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Furthermore, since numerous modifications and changes will readily occur to those of skill in the art, it is not desired to limit the invention to the exact construction and operation described herein. Accordingly, all suitable modifications and equivalents should be considered as falling within the spirit and scope of the invention.

What is claimed is:

1. A computer implemented method for calibrating a permeability of a rock formation, the method comprising:
inputting, into the computer, a measured product KH of a measured permeability K and a flowing zone thickness H over a plurality of corresponding zones in one or more wells;
inputting, into the computer, porosity logs for each measured product KH in each of the plurality of corresponding zones obtained from the one or more wells;
reading, by the computer, a porosity-permeability cloud of data points;
calculating, by the computer, for each zone, a predicted product KH from the porosity log using the porosity-permeability cloud of data points; and
determining, by the computer, one or more weighting coefficients between the predicted KH and the measured KH corresponding to each zone; and
calibrating the measured permeability corresponding to each zone using the one or more weighting coefficients.

2. The method according to claim 1, further comprising determining a relative score range for an accuracy of the measured product KH and a lower limit and an upper limit for the measured product KH.

3. The method according to claim 1, further comprising inputting an index log representing one or more facies of rock formation for a geological area of interest.

4. The method according to claim 3, wherein the calculating comprises calculating for each zone and for the one or more facies the predicted product KH from the porosity log using the porosity-permeability cloud of data points.

5. The method according to claim 3, wherein the calculating comprises determining an average permeability for any depth in a zone with a log porosity P such that the porosity P is within a cumulative probability tolerance of porosity P.

6. The method according to claim 5, wherein the calculating comprises calculating a log KH for a given facies f by calculating a sum of the product of the average permeability K by flowing zone thickness H over data samples j that are within the given facies f.

7. The method according to claim 6, wherein determining the weighting coefficient comprises determining a plurality of weighting coefficients for the one or more facies by applying a non-affine multiple linear regression or weighted power law fit to obtain the measured KH.

8. The method according to claim 7, further comprising applying a Monte Carlo method to the non-affine multiple linear regression or weighted power law fit.

9. The method according to claim 8, wherein the Monte Carlo method comprises randomly drawing the plurality of weighting coefficients from a relative accuracy range of a corresponding well test and randomly drawing the measured product KH between an upper limit and a lower limit.

10. The method according to claim 8, further comprising creating a dynamic statistical distribution from the Monte Carlo method using a ranking method.

11. The method according to claim 10, wherein the dynamic statistical distribution comprises a P10, P50 and P90 distribution.

12. A system for calibrating a permeability of a rock formation, comprising:
a computer readable memory configured to store input data comprising a measured product KH of a measured permeability K and a flowing zone thickness H over a plurality of corresponding zones in one or more wells, and porosity logs for each measured product KH in each of the plurality of zones obtained from the one or more wells; and
a computer processor in communication with the computer readable memory, the computer processor being configured to:
read a porosity-permeability cloud of data points;
calculate, for each zone, a predicted product KH from the porosity log using the porosity-permeability cloud of data points;
determine a weighting coefficient between the predicted KH and the measured KH corresponding to each zone; and
calibrate the measured permeability corresponding to each zone using the one or more weighting coefficients.

13. The system according to claim 12, wherein the processor is configured to determine a relative score range for an accuracy of the measured product KH and a lower limit and an upper limit for the measured product KH.

14. The system according to claim 12, wherein the memory is configured to store an input index log representing one or more facies of rock formation for a geological area of interest.

15. The system according to claim 14, wherein the processor is configured to calculate for each zone and for the one or more facies the predicted product KH from the porosity log using the porosity-permeability cloud of data points.

16. The system according to claim 14, wherein the processor is configured to determine an average permeability for any depth in a zone with a log porosity P such that the porosity P is within a cumulative probability tolerance of porosity P.

17. The system according to claim 16, wherein the processor is configured to calculate a log KH for a given facies f by calculating a sum of the product of the average permeability K by flowing zone thickness H over data samples j that are within the given facies f.

18. The system according to claim 17, wherein the processor is configured to determine a plurality of weighting coefficients for the one or more facies by applying a non-affine multiple linear regression or weighted power law fit to obtain the measured KH.

19. The system according to claim 18, wherein the processor is configured to apply a Monte Carlo method to the non-affine multiple linear regression or weighted power law fit

20. The system according to claim 19, wherein the Monte Carlo method comprises randomly drawing the plurality of weighting coefficients from a relative accuracy range a corresponding well test and randomly drawing the measured product KH between an upper limit and a lower limit.

21. The system according to claim 19, wherein the processor is configured to create a dynamic statistical distribution from the Monte Carlo method using a ranking method.

22. The system according to claim 21, wherein the dynamic statistical distribution comprises a P10, P50 and P90 distribution.

23. A computer implemented method for calibrating a permeability of a rock formation, the method comprising:
inputting, into the computer, a measured product KH of permeability K by flowing zone thickness H over a plurality of corresponding zones in one or more wells;
inputting, into the computer, permeability logs for each measured product KH in each of the plurality of corresponding zones obtained from the one or more wells;
calculating, by the computer, for each zone, a predicted product KH from the permeability log;
determining, by the computer, one or more weighting coefficients between the predicted KH and the measured KH corresponding to each zone; and
calibrating the measured permeability corresponding to each zone using the one or more weighting coefficients.

24. The method according to claim 23, further comprising determining a relative score range for an accuracy of the measured product KH and a lower limit and an upper limit for the measured product KH.

25. The method according to claim 23, further comprising inputting an index log representing one or more facies of rock formation for a geological area of interest.

26. The method according to claim 25, wherein determining the weighting coefficient comprises determining a plurality of weighting coefficients for the one or more facies by applying a non-affine multiple linear regression or weighted power law fit to obtain the measured KH.

27. The method according to claim 26, further comprising applying a Monte Carlo method to the non-affine multiple linear regression or weighted power law fit.

28. The method according to claim 27, wherein the Monte Carlo method comprises randomly drawing the plurality of weighting coefficients from a relative accuracy range of a corresponding well test and randomly drawing the measured product KH between an upper limit and a lower limit.

29. The method according to claim 28, further comprising creating a dynamic statistical distribution from the Monte Carlo method using a ranking method.

30. The method according to claim 29, wherein the dynamic statistical distribution comprises a P10, P50 and P90 distribution.

31. A system for calibrating a permeability of a rock formation, comprising:
a computer readable memory configured to store input data comprising a measured product KH of a measured permeability K and a flowing zone thickness H over a plurality of corresponding zones in one or more wells, and permeability logs for each measured product KH in each of the plurality of zones obtained from the one or more wells; and
a computer processor in communication with the computer readable memory, the computer processor being configured to:
calculate, for each zone, a predicted product KH from the permeability log;
determine a weighting coefficient between the predicted product KH and the measured product KH corresponding to each zone; and
calibrate the measured permeability corresponding to each zone using the one or more weighting coefficients.

32. The system according to claim 31, wherein the processor is configured to determine a relative score range for an accuracy of the measured product KH and a lower limit and an upper limit for the measured product KH.

33. The system according to claim 31, wherein the memory is configured to store an input index log representing one or more facies of rock formation for a geological area of interest.

34. The system according to claim 33, wherein the processor is configured to calculate a log KH for a given facies f by calculating a sum of the product of the average permeability K by flowing zone thickness H over data samples j that are within the given facies f.

35. The system according to claim 34, wherein the processor is configured to determine a plurality of weighting coefficients for the one or more facies by applying a non-affine multiple linear regression or weighted power law fit to obtain the measured KH.

36. The system according to claim 18, wherein the processor is configured to apply a Monte Carlo method to the non-affine multiple linear regression or weighted power law fit.

37. The system according to claim 36, wherein the Monte Carlo method comprises randomly drawing the plurality of weighting coefficients from a relative accuracy range a corresponding well test and randomly drawing the measured product KH between an upper limit and a lower limit.

38. The system according to claim 37, wherein the processor is configured to create a dynamic statistical distribution from the Monte Carlo method using a ranking method.

39. The method according to claim 38, wherein the dynamic statistical distribution comprises a P10, P50 and P90 distribution.
